(19) United States
(12) Patent Application Publication
(10) Pub. No.: US 2015/0099169 A1
(43) Pub. Date: Apr. 9, 2015

(54) HIGH ENERGY DENSITY MULTIVALENT CONVERSION BASED CATHODES FOR LITHIUM BATTERIES

(71) Applicant: UT-BATTELLE, LLC, Oak Ridge, TN (US)

(72) Inventors: Nancy J. DUDNEY, Knoxville, TN (US); Jagjit NANDA, Knoxville, TN (US); Surendra Kumar MARTHA, Nuagaon/Nayagarh (IN)

(21) Appl. No.: 14/047,722

(22) Filed: Oct. 7, 2013

(51) Int. Cl. H01M 4/36; H01M 4/587; H01M 4/62; H01M 4/58; H01M 4/525; H01M 4/583

(52) U.S. Cl. CPC H01M 4/366; H01M 4/525; H01M 4/5835; H01M 4/621; H01M 4/582; H01M 4/587; H01M 4/5805
USPC 429/217; 429/231.8; 429/221; 429/231.7; 429/220; 429/223; 429/231.5

(57) ABSTRACT

An electrode for a battery includes a plurality of electrochemically active conversion-based particles coated by multilayer graphene, a plurality of carbon fibers, and a carbonaceous binder. The carbonaceous binder binds the active particles coated with the multilayer graphene to the plurality of carbon fibers. A battery containing the electrode and a method of making an electrode and a battery containing the electrode are also disclosed.

### STATEMENT REGARDING FEDERALLY SPONSORED RESEARCH

This invention was made with government support under contract No. DE-AC05-00OR22725 awarded by the U.S. Department of Energy. The government has certain rights in this invention.

### FIELD OF THE INVENTION

This invention relates generally to battery electrodes, and more particularly to lithium battery electrodes.

### BACKGROUND OF THE INVENTION

High energy density electrochemical energy storage has been an area of intense study during the last decade. Specifically, there has been significant research progress towards developing alternate chemistries that can reversibly store more charge (capacity) at the gravimetric and/or volumetric basis compared to the current state-of-the art intercalation based lithium-ion systems. Examples include metal-air redox couples, lithium-sulfur, and multivalent chemistries based on conversion, alloying and displacement mechanisms. Multivalent conversion based binary and ternary compounds have been a subject of particular recent interest because of their high specific capacity originating from multiple oxidation states over a relatively large voltage window. Yet, harvesting reversible multi-electron capacity from multivalent systems presents many challenges due to intrinsic materials limitations arising from (i) extremely poor electronic conductivity, (ii) poor transport and interfacial charge transfer kinetics, and (iii) structural instability during multi-electron charge transfer. A combination of these factors lead to rapid capacity loss and significant hysteresis during charge-discharge cycles. A large hysteresis implies a poor round trip energy efficiency that makes conversion based electrodes impractical for most applications.

The origin of such large hysteresis in the multivalent systems is attributed to various overpotentials, which are suspected to be due to charge transfer (electronic or ionic), ohmic or concentration driven effects. For example, in case of iron fluorides, a major part of the hysteresis could originate from the intrinsically slow diffusion of Fe verses Li during the reconversion process that could also favor formation of intermediate phases that are kinetically driven. In addition, iron fluorides (FeF₃ and FeF₂) are highly ionic solids and therefore extremely insulating in nature. These and other factors limit the use of iron fluorides for high capacity batteries despite their very high theoretical specific capacity of 712 mAhg⁻¹ which is based on transfer of three moles of lithium per mole of Fe. There have been numerous reports in the literature directed towards improving the charge transfer kinetics and transport through various means: (i) by reducing the particle size, (ii) optimizing their morphology (or both), and (iii) enhancing the local electronic conductivity by carbon coating or addition of highly conducting diluents such as multilayer graphenes (MLG) or conductive carbon. However, to date, such improvements are not sufficient for using iron fluorides as practical electrodes for rechargeable battery applications.

### SUMMARY OF THE INVENTION

An electrode for a battery includes a plurality of electrochemically active conversion-based particles coated by multilayer graphene; a plurality of carbon fibers; and, a carbonaceous binder binding the multilayer graphene coated particles to the plurality of carbon fibers.

The active particles can comprise iron fluorides, iron oxyfluorides, iron oxynitrofluorides and iron nitrides. The iron-containing active particles can comprise at least one selected from the group consisting of FeF₂, FeF₃, and FeOₓF₁₋ₓ, where x=0 to 0.5.

The carbon fibers can have a diameter of between 100 nm and 5 microns. The carbon fibers can be in the form of a woven mat. The mat can have a thickness of between 100 microns and 1 millimeter.

The carbonaceous binder can be any suitable hydrocarbon, and in one embodiment can be a pitch.

The loading of active particles can be between 2-15 mg/cm². The electrode thickness can be between 100-250 microns and the loading of active particles is between 2-6 mg/cm². The electrode thickness can be between 300 microns and 1 mm and the loading of iron-containing active materials is between 6-15 mg/cm².

The pitch precursor and active particles can comprise between 5-15 wt % based on the total weight of the electrode. The pitch precursor and active particles each can comprise between 5-15 wt % of the total electrode weight. The multilayer graphene can comprise between 10-25 wt % of the total electrode weight.

The active particles can be between 5-50 nm. The active particles can be provided in secondary aggregates of between 1 and 5 microns. The multilayer graphene can comprise platelets having a thickness of between 5 nm and 25 nm. The multilayer graphene can comprise platelets having a diameter of between 5 and 20 microns.

The electrode of the invention can be provided in a battery. A battery comprises an electrode, the electrode comprising a plurality of electrochemically active conversion-based particles coated by multilayer graphene; a plurality of carbon fibers; and, a carbonaceous binder binding the multilayer graphene coated particles to the plurality of carbon fibers.

The electrochemically active conversion-based particle can comprise at least one selected from the group consisting of transition metal fluorides, oxides, nitrides, oxynitrides, and phosphides. The electrochemically active conversion-based particle can comprise at least one selected from the group consisting of Fe₂O₃, Fe₃O₄, CoO, Co₃O₄, CuO, Cu₂O, Co₃N, VN, FeP_{y}, where y=0.33, 0.5, 1, 2, and 4, NiP_{y}, where y=0.33, 0.5, 2, and 3, CuP₂, and CrF₃/C.

A method of making a battery, includes the steps of providing a plurality of electrochemically active conversion-based particles; coating the active particles with a multilayer graphene; mixing the active particles coated with the multilayer graphite with carbon fibers and a carbonaceous binder; and carbonizing the carbonaceous binder to bind the active particles coated with multilayer graphene to the carbon fibers. The carbonization step can be conducted at temperatures of between 400-600° C.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic diagram of an electrode fabrication process for Iron (II) and (III) fluoride cathodes.

FIGS. 2 (a)-(e) are SEM and STEM images showing typical shapes and sizes of FeF₂ and FeF₃ particles and electrodes (a) pristine FeF₃/FeF₂-MLG carbon fiber electrode, (b) FeF₃ and MLG after electrode fabrication at 450° C., (c) A dark field HRTEM of FeF₃ particle surrounded by MLG, (d) FeF₂-MLG after electrode fabrication at 450° C. (e) Raman spectra for the MLG and composite carbon fiber electrode.

FIG. 3 are SEM images showing typical shapes and sizes of FeF₂ and FeF₃ particles and electrodes (a) pristine FeF₃ powder (as received), (b) pristine MLG, (c) pristine FeF₃ after electrode fabrication at 600° C., and (d) pristine FeF₂ powder (as received).

FIGS. 4 (a)-(d) are voltage vs. capacity profiles of Li/FeF₃ cell at 25° C. on (a) conventional slurry on Al foil, (b) FeF₃ carbon fiber electrode cycled between 4.5-1.5 V (C/50 rate) at 25° C. Capacity plotted as a function of cycle number for the Li/FeF₃ cell for the (c) conventional slurry coated on Al foil, (d) FeF₃ on carbon fiber 3D electrode. All capacity was evaluated based on FeF₃ active material alone.

FIG. 5 is (a) voltage vs. capacity profiles of Li/FeF₃ cell (on carbon fiber) cycled between 1.0 V and 4.5 V (C/50 rate) at 25° C.; and (b) capacity plotted as a function of cycle number for the Li/FeF₃ cell.

FIG. 6 is XRD patterns for the FeF₂ and FeF₃ pristine and cycled (at least 30 times) composite electrodes. The XRD pattern of the carbon fiber is supplied as reference. The peak from LiF and Fe is denoted by # and * respectively.

FIGS. 7 (a)-(b) are (a) voltage vs. capacity profiles of a Li/FeF₃ cell (on carbon fiber) cycled between 1.5 V and 4.5 V (C/50 rate) at 60° C.; and (b) capacity plotted as a function of cycle number for the Li/FeF₃ cell. Capacity is evaluated based only on FeF₃ active material.

FIGS. 8 (a)-(b) are (a) rate performance of the FeF₃-MLG carbon fiber electrode, cycled beteen 1.0 V and 4.5 V; and (b) the corresponding voltage profiles at different rates.

FIGS. 9 (a)-(d) are STEM images (a) bright field, (b) Z-contrast of FeF₃ from pristine electrode and (c) bright field, (d) Z-contrast of FeF₃ from cycled electrode after cycling between 1.5 V and 4.5 V after 50 cycles at 60° C.

FIGS. 10 (a)-(b) are (a) voltage vs. capacity profiles of a Li/FeF₂ cell (on carbon fiber) cycled between 1.0 V and 4.5 V (C/50 rate) at 25° C.; (b) capacity plotted as a function of cycle number for the Li/FeF₂ cell. Capacity is evaluated based on FeF₂ active material.

FIGS. 11 (a)-(b) are (a) voltage vs. capacity profiles of a Li/FeF₂ cell (on Al-foil) cycled between 1.0 V and 4.5 V (C/50 rate) at 25° C.; and (b) capacity plotted as a function of cycle number for the Li/FeF₂ cell. The electrode composition is FeF₂ (50%), graphene (40%), PVDF (10%) on Al foil.

### DETAILED DESCRIPTION OF THE INVENTION

An electrode for a battery includes a plurality of electrochemically active conversion-based particles coated by multilayer graphene, a plurality of carbon fibers, and a carbonaceous binder. The carbonaceous binder binds the multilayer graphene coated particles to the plurality of carbon fibers.

The electrochemically active conversion-based particles can comprise a number of such electrochemically active-conversion-based materials that have utility for battery electrodes, including cathode and anode materials. Many such materials are known and have been reported in the literature. Electrochemically active conversion-chemistry based electrode materials are known to present many challenges to successful utilization in batteries, including electronic conductivity and ionic diffusion. These challenges are addressed by the present invention.

The electrochemically active conversion-based materials that are useful in the invention can comprise iron fluorides, iron oxyfluorides, iron oxynitrofluorides and iron nitrides. The iron-containing active particles comprise at least one selected from the group consisting of FeF₂, FeF₃, and FeOₓF₁₋ₓ, where x=0 to 0.5. The electrochemically active conversion-based particles can comprise an array of binary and ternary phases of transition metals. These include, without limitation, fluorides, oxides, nitrides, oxynitrides, and phosphides. Examples include but are not limited to Fe₂O₃, Fe₃O₄, CoO, Co₃O₄, CuO and Cu₂O, Co₃N, VN, FeP_{y}, where y=0.33, 0.5, 1, 2, and 4, NiP_{y}, where y=0.33, 0.5, 2, and 3, CuP₂, and CrF₃/C.

The active particles can be between 5-50 nm. The iron-containing active particles can be provided in secondary aggregates of between 1 and 5 microns.

The multilayer graphene can take several forms. The multilayer graphite can comprise platelets having a thickness of between 5 nm and 25 nm. The multilayer graphene can comprise platelets having a diameter of between 5 and 20 microns. The MLGs are prepared by chemical vapor deposition method.

The carbon fibers can be any suitable carbon fibers. The carbon fibers can be graphitic or non-graphitic. The carbon fibers can be derived from a wide range of precursors example include but not limited to polyacrylonitirile (PAN), polyolefins or petroleum pitch and rayon. The carbon fibers can have a diameter of between 100 nm and 5 microns. The carbon fibers can be in the form of a woven mat. The mat can have a thickness of between 100 microns and 1 millimeter. The carbonaceous binder can comprise any suitable hydrocarbons that can be carbonized at low temperatures (˜400° C.). In one aspect, the carbonaceous binder comprises pitch. The pitch can be a mesophase pitch.

The loading of active particles is between 2-15 mg/cm². The electrode thickness can be between 100-250 microns and the loading of active particles can be between 2-6 mg/cm². The electrode thickness can be between 300 microns and 1 mm and the loading of active materials can be between 6-15 mg/cm².

The pitch precursor and active particles can comprise between 5-15 wt. % based on the total weight of the electrode. The pitch precursor and active particles can each comprise between 5-15 wt. % of the total electrode weight. The multilayer graphene (MLG) can comprise between 10-25 wt. % of the total electrode weight. Typical loading of Iron (II) and Iron (III) powder to carbon fiber mat achieved with this technique is can range between 1:1 to 3:1 on a wt/wt basis a is limited by the viscosity of the slurry that is used to coat the powders.

The typical ratio of the solid active materials (iron fluoride) and MLG and pitch to NVP can typically range between 1:1.5 to 1:3 on a wt/wt % basis and is only limited by the viscosity of the slurry.

The electrode can be provided in a battery. A battery comprising the electrode includes a plurality of electrochemically active conversion-based particles coated by multilayer graphene, a plurality of carbon fibers, and a hydrocarbon binder. The hydrocarbon binder binds the multilayer graphene coated particles to the plurality of carbon fibers. The battery can be a lithium battery.

A method of making an electrode includes the steps of providing a plurality of electrochemically active conversion-based particles, coating the active particles with a multilayer graphene, mixing the active particles coated with the multilayer graphene with carbon fibers and a carbonaceous binder, and carbonizing the carbonaceous binder to bind the active particles coated with multilayer graphene to the carbon fibers.

The particle size of the electrochemically active conversion-based material can be reduced by appropriate techniques such as, without limitation, dry ball milling. The electrochemically active conversion-based particles can be combined with the multilayer graphene and mixed. The pitch can be combined with a suitable solvent such as N-Vinyl-2-pyrrolidone (NVP), and then combined with the active particles and graphene to create a slurry. The slurry can be coated or loaded on to the carbon fibers or fiber mat and then carbonized to anneal the active particles and multilayer graphene to the carbon fibers.

The carbonization step can be conducted at temperatures of between 400-600° C. The carbonization can be between 400-500° C. The duration of the carbonization step can be for a suitable temperature and time period to complete the carbonization. In one aspect, the carbonization if for a duration of at least 5 hours.

The role of electrode architecture on the capacity retention and hysteresis of iron (II and III) fluoride compounds and performance with electrodes fabricated using conventional slurry based approach having similar sized iron fluoride particles can illustrate the invention. The latter approach does not involve any kind of electrode architecture. The electrode architecture process of the invention has (i) individual nanosized iron fluoride particles (25-50 nm size range) coated or locally surrounded with MLG to enhance their local electronic conductivity. These FeF₃-MLG (or FeF₂-MLG), coated particles are bound to an electronic backbone or current collector comprising an interconnected network of carbon fibers having diameter typically ranging between 5-9 μm. This is made possible by using a mesophase pitch carbon (petroleum pitch: p-pitch) as the conductive binder between FeF₃-MLG and carbon fibers. The results demonstrate that the carbon fiber-pitch based electrode architecture produces a significant reduction of hysteresis between the charge and discharge, from ˜2 V for the conventional slurry based iron fluoride electrode, to about 0.9 V for the carbon fiber based matrix. This also enables the invention to obtain reversible capacity utilization of >450 mAhg⁻¹ for FeF₃ with stable cycling (>30 cycles at 25° C.). Furthermore, cycling at elevated temperature (at 60° C.), improves the reaction and/or transport kinetics yielding almost theoretical specific capacity (700 mAhg⁻¹) with a good cycle life and additional reduction in the hysteresis. The estimated overall energy density based on the active mass of FeF₃ in the electrode is about 1650 Wh kg⁻¹ covering both the intercalation and conversion window (1.5-4.5 V).

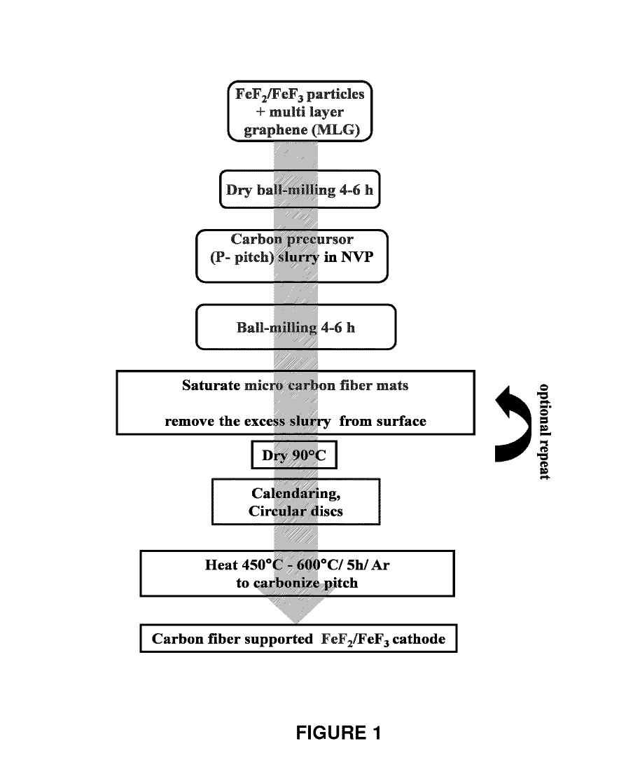

The synthesis and processing of iron fluoride-carbon fiber 3D composite electrode architecture is illustrated in a schematic diagram shown in FIG. 1. FeF₃/FeF₂ powders were purchased from Sigma-Aldrich. The as received FeF₃ powders had average particle size in the range of 0.5 μm size (spherical shape) and FeF₂ particles had a rod like morphology. MLG was obtained from Graphene Supermarket. The average flake or platelet thickness was about 8 nm and BET surface area ˜100 m²g⁻¹. The FeF₃-MLG nanocomposites were fabricated using a high-energy ball milling process (model 8000M Mixer/Mill), by mixing FeF₃ or FeF₂ with 20 wt. % MLG for 4-6 hours. FeF₃-MLG composite powders were then mixed with 5% petroleum pitch (Cytec Industries Inc., USA) in N-Vinyl-2-pyrrolidone (Aldrich) to make homogenous slurry using a turbula. The slurry was then coated onto the carbon fibers (non-graphitic) and any excess slurry was carefully removed from the surface followed by drying at 90° C. under vacuum. The composite electrodes were then pressed at 1 ton cm⁻² and punched into an electrode disc of 1 cm² area for the carbonization/annealing process.

Controlled experiments were performed to determine the optimal carbonization temperature for the pitch to have required electronic conductivity but does not increase the particle size or agglomeration. The optimal carbonization temperature was found to be in the vicinity of 450° C. Further increasing the annealing temperature, for instance to 600° C., can increase the carbonization of pitch, providing better electronic conductivity but it affects the electrochemical performance. Below 400° C., p-pitch does not carbonize well, resulting in the presence of organic impurities, reducing the electrochemical performance. The working electrodes comprised of ˜5 mg of active FeF₃ per cm². The processing and fabrication method for FeF₂ electrodes was similar to FeF₃ as mentioned above. Iron fluoride electrodes were also prepared by the conventional approach. Briefly, this consists of slurry of ball milled FeF₃/FeF₂, MLG, and polyvinylidene fluoride (PVDF) (Aldrich) in wt. % ratio of 50:40:10 (hereafter ‘conventional electrodes’) using N-methylpyrrolidone (NMP). It is noted that percentage of carbon diluent (MLG) is very high due to the insulating nature of iron fluoride particles. Both electrodes have a loading of ˜5 mg of active FeF₃/FeF₂ per cm² on Al or carbon fiber. The final electrode thicknesses range between 75-150 μm.

Scanning electron microscopy (Hitachi S-4800 scanning electron microscope) and transmission electron microscopy (Hitachi HF3300 S/TEM) were utilized to examine the morphology and particles of the carbon fiber 3D structured electrode. The HF3300 S/TEM, operated at 300 kV and equipped with a Bruker silicon drift EDS detector, was used to obtain high angle annular dark field (HAADF) STEM images and qualitative EDS maps. Raman studies were performed using a Witec model alpha 300 R Confocal Raman Microscope.

The electrochemical performance of the cathodes comprising FeF₃ and FeF₂ as the active mass was evaluated using coin-type cell geometry (CR2032, Hohsen Corp. Japan) with a 25 μm microporous trilayer membrane (polypropylene/polyethylene/polypropylene) separator (type 2325, Celgard Inc., USA). Lithium foils (purity 99.9%, Alfa Aesar) were used as counter electrode. The electrolyte solution was 1.2 M LiPF₆ in a 1:2 mixture of ethylene carbonate (EC) and dimethyl carbonate (DMC) by weight (battery grade, Novolyte Technologies, USA). Electrochemical cells were assembled in glove box (Innovative Technology, Inc., USA) under high purity argon atmosphere. After assembling, the cells were stored at room temperature for about 12 h to ensure complete impregnation of the electrodes and separators with the electrolyte solution. Galvanostatic charge-discharge cycling was carried out using a multichannel battery tester (model 4000, Maccor Inc., USA) in two-electrode coin-type cells. The cells were cycled under constant current condition between the 4.5-1.5 V voltage window and until 1 V in some cases.

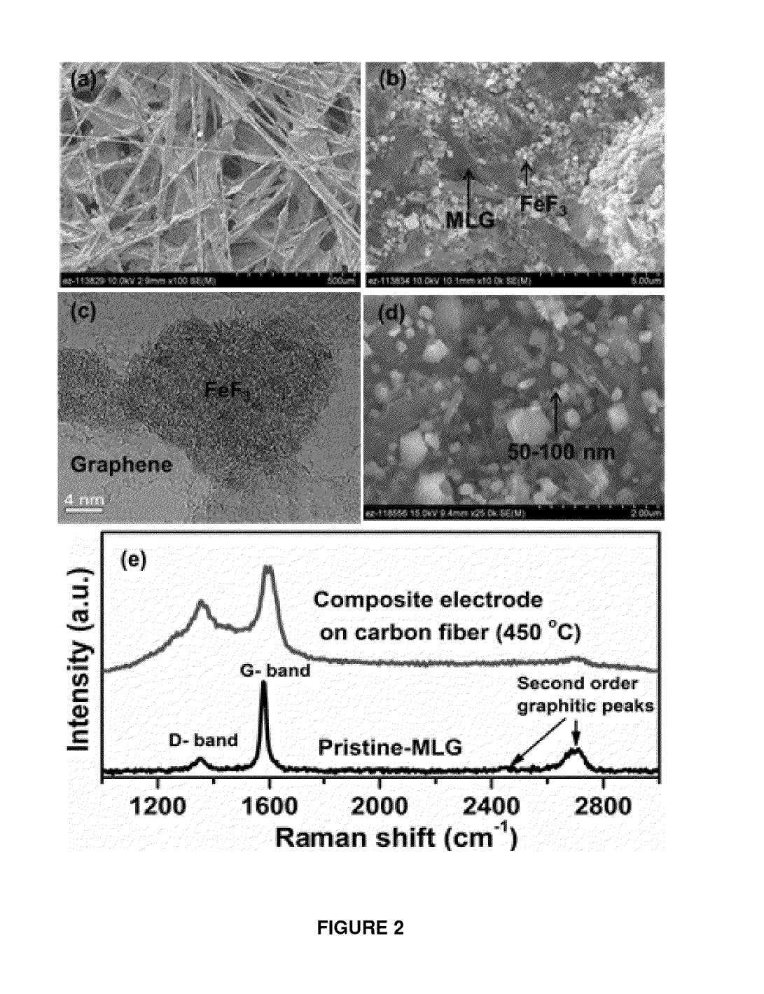

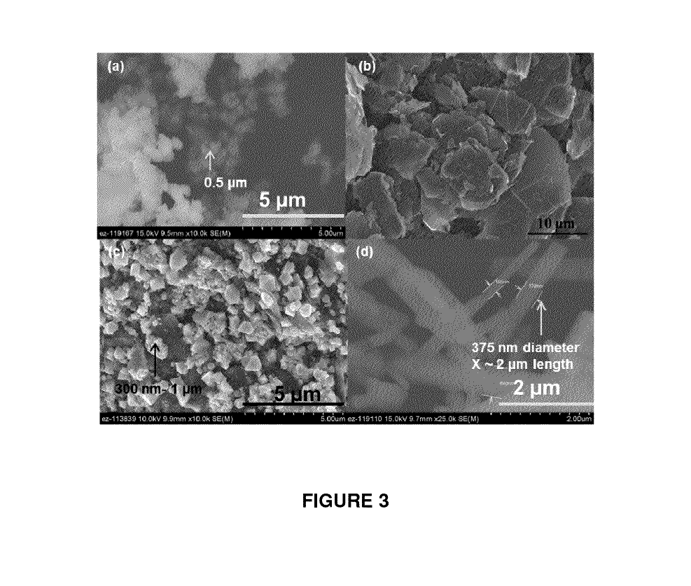

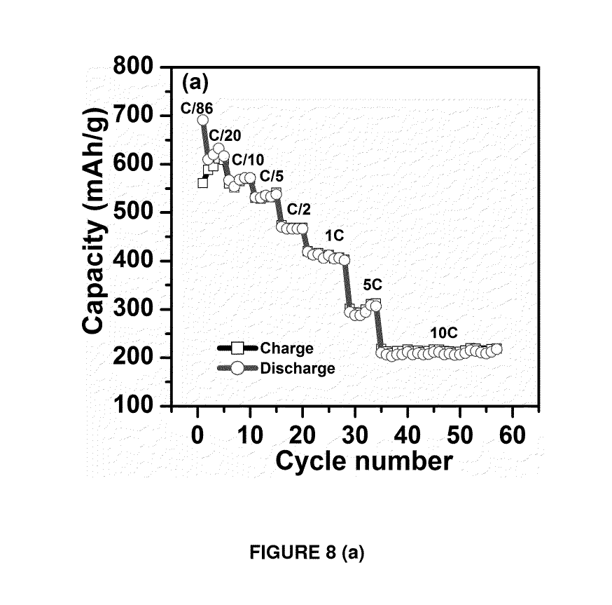

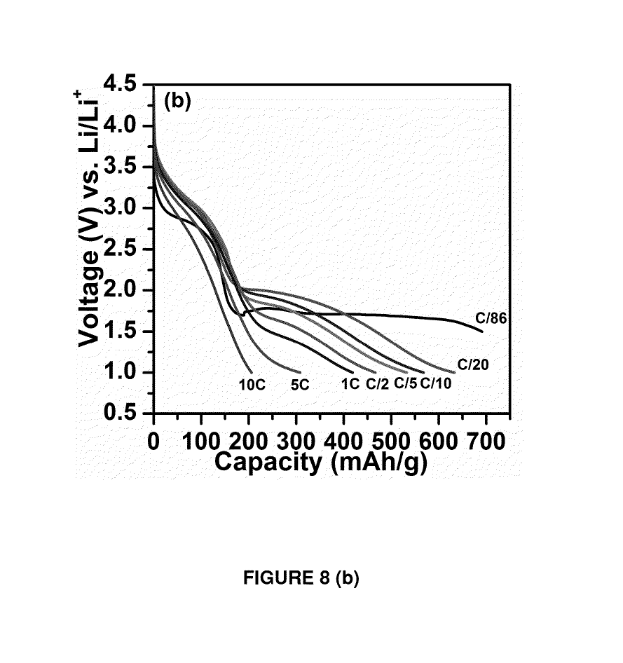

FIGS. 2 (a)-(e) are SEM and STEM images showing typical shapes and sizes of FeF₂ and FeF₃ particles and electrodes (a) pristine FeF₃/FeF₂-MLG carbon fiber electrode, (b) FeF₃ and MLG after electrode fabrication at 450° C., (c) a dark field HRTEM of FeF₃ particle surrounded by MLG, (d) FeF₂-MLG after electrode fabrication at 450° C., and (e) Raman spectra for the MLG and composite carbon fiber electrode. The SEM images in FIG. 2 (a, b) clearly show that the FeF₃ crystallites are intimately embedded within the carbon fiber and multilayered graphene platelets. The pristine FeF₃ material has nearly spherical morphology with an initial aggregated particle size of 0.5 μm. After high energy mechanical milling the primary sizes are in the range of 25-50 nm and does not aggregate under carbonization process at 450° C. as shown in FIG. 2 (c) and STEM images FIG. 8 (a, b) discussed later. FIG. 3 are SEM images showing typical shapes and sizes of FeF₂ and FeF₃ particles and electrodes (a) pristine FeF₃ powder (as received), (b) pristine MLG, (c) pristine FeF₃ after electrode fabrication at 600° C., and (d) pristine FeF₂ powder (as received). The pristine FeF₂ materials have rod like structure with particle size of −2 μm in length and about 400 nm in width (FIG. 3d). After similar mechanical milling and carbonization steps, the final FeF₂ particles are approximately a factor of two larger than FeF₃, about 50-100 nm (FIG. 2d). FIG. 2e (lower panel) shows the Raman spectrum of the MLGs, reflecting the strong graphitic nature of the material. The strong graphitic peak at 1590 cm⁻¹ and a weak defect (D) band at 1350 cm⁻¹ suggest that the MLGs are highly conducting with carbon atoms mainly having sp² type bond symmetry. This is further supported by observation of second order peaks at 2700 and 2450 cm⁻¹. Compared to pristine MLG the Raman bands of FeF₃-MLG carbon fiber composite electrodes are significantly broadened FIG. 2e (upper panel) with a different D to G ratio and spectral widths. This can be primarily due to two aspects (i) non-graphitic nature of carbon fibers used as the current collector (ii) effect of annealing that can induce defects or agglomeration of graphitic platelets.

The carbon fiber network provides multifunctionality, including (i) the electronic backbone necessary for highly ionic compounds such as iron fluorides for full capacity retention; (ii) an active 3D current collector and thus eliminates the use of separate metallic current collector. Further, the use of P-pitch based carbon binder eliminates the use of organic inactive binders such as polyvinylidene difluoride (PVDF). The carbon fibers used have a conductivity of 1.6×10³ S cm⁻¹, which is ˜2 orders of magnitude smaller than the Al foil current collector (3.7×10⁵ S cm⁻¹), and the fiber diameter is about 7-9 μm.

To identify the role of electrode architecture towards improving the electrochemical performance of highly ionic compound such as iron fluoride, a comparison of performance of the conventional slurry casted electrode versus the carbon fiber based 3D architecture was made. The average particle sizes of FeF₃/FeF₂ in both cases were similar. The primary exception is the weight fraction of carbon additive (MLG). For the convention slurry approach electrode composition consist of about 50:40 wt. % iron fluoride: MLG and 10% binder (PVDF). For the carbon fiber based approach the ratio is 75:20 wt. % and 5% carbonized pitch. The higher MLG composition was necessary due to the extremely poor intrinsic electronic conductivity of iron fluorides. The specific capacity and cyclability of FeF₃-MLG composite on fiber architecture electrode were directly evaluated by charge-discharge measurements at low current rate (C/50 rate), at room temperature (25° C.) as well as at 60° C. Separate experiments were performed for pure phases of MLG, pitch based carbon and carbon fibers to verify that they do not have any capacity contribution within the cycling voltage range (4.5-1 V) (data not shown here).

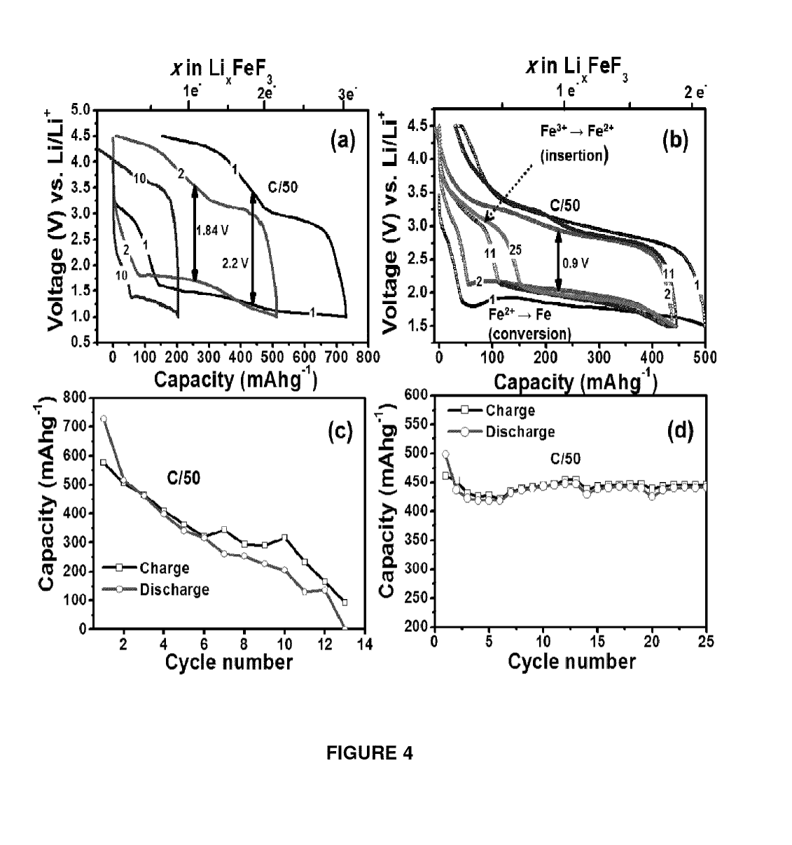

FIGS. 4 (a)-(d) are voltage vs. capacity profiles of Li/FeF₃ cell at 25° C. on (a) conventional slurry on Al foil, (b) FeF₃ carbon fiber electrode cycled between 4.5-1.5 V (C/50 rate) at 25° C. with capacity plotted as a function of cycle number for the Li/FeF₃ cell for the (c) conventional slurry coated on Al foil, (d) FeF₃ on carbon fiber 3D electrode. All capacity was evaluated based on FeF₃ active material alone. The first discharge capacity for the conventional slurry casted FeF₃-MLG electrodes shows capacity in excess of 700 mAhg⁻¹ (FIG. 4a), which corresponds to reaction of 3 moles of Li per mole of Fe metal. The first plateau, between 3.5 to 3 V, corresponds to a reduction of Fe³⁺ to Fe²⁺ via an insertion or intercalation type mechanism (reaction 1). The plateau at 1.8 V corresponds to a reduction of Fe²⁺ to Fe⁰ via a conversion reaction (reaction 2).

FeF₃+Li⁺+e⁻=LiFeF₃ (1)

LiFeF₃+2Li⁺2e⁻=Fe⁰+3LiF (2)

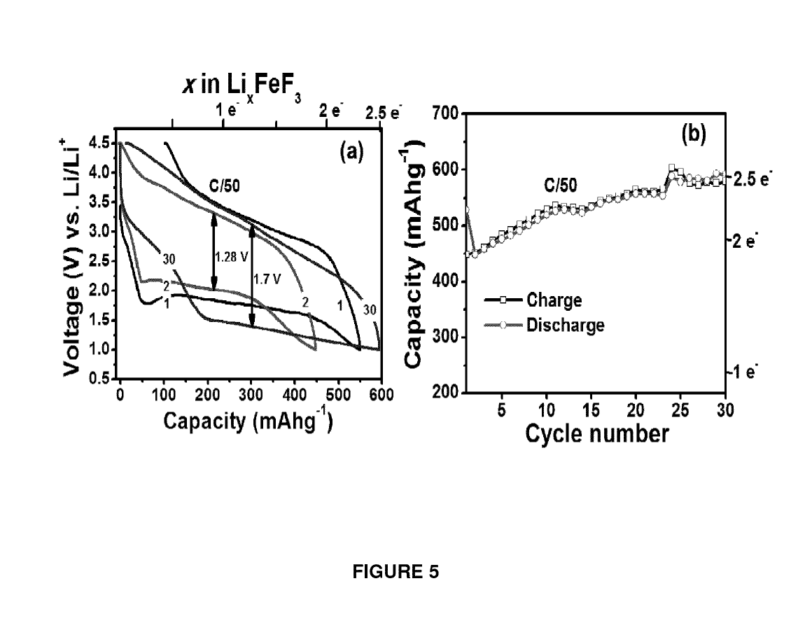

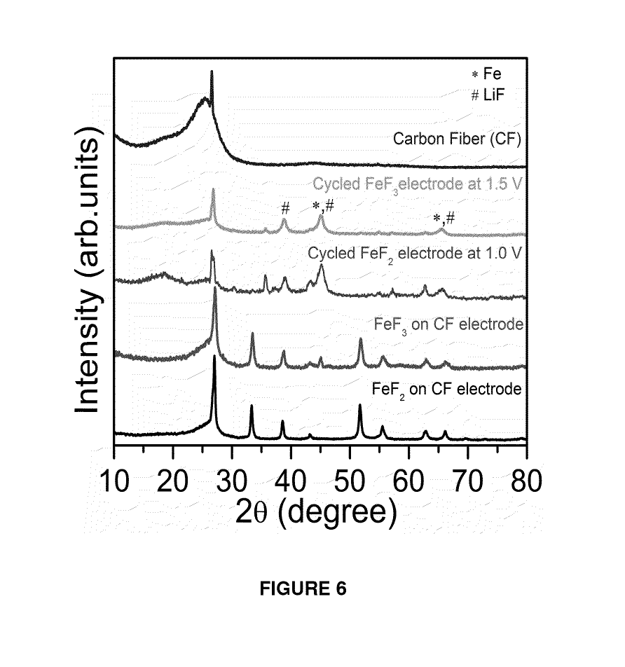

Without wishing to be limited, it is believed that FeF₃ first undergoes insertion up to Li_{0.5}FeF₃ with a rutile like structure, followed by extrusion of LiF and insertion of more lithium up to LiFeF₃ (reaction step 1) and finally forming a mixture of α-Fe and LiF as part of the conversion reaction that overall involves a 2 electron transfer (reaction 2). At the end of the conversion step the starting LiFeF₃ phase is fully converted to Fe—LiF phase. The slurry based FeF₃ electrode has capacity retention that is very poor with virtually no capacity remaining at the end of 12 cycles. This is even with a higher carbon loading of 40 wt % (FIG. 4c). On the contrary, FeF₃-MLG coated on the carbon fiber matrix shows much improved performance. The first discharge capacity ˜500 mAh g⁻¹ (>2 electron capacity) in the potential range 4.5 V and 1.5 V (FIG. 4b) and 550 mAh g⁻¹ if cycled in the potential window of 4.5-1.0 V (FIG. 5). Differences were detected between the charge-discharge profiles of slurry versus 3D carbon fiber FeF₃ electrodes. Most notably, the first few discharge profiles of 3D fiber electrodes (FIG. 4b) show very little intercalation capacity in the 3.5-3 V region unlike for conventional FeF₃ electrodes. But under continuous cycling a clear intercalation plateau characteristic of FeF₃ is found. Further investigation suggests that the annealing (at 450° C.) of FeF₃ nanosized particles in the presence of MLG (carbon) and pitch in argon atmosphere can lead to reduction of FeF₃ to mainly FeF₂ phase. This is further confirmed by x-ray diffraction (XRD) results shown in FIG. 6. FIG. 6 is XRD patterns for the FeF₂ and FeF₃ pristine and cycled (at least 30 times) composite electrodes. The XRD pattern of the carbon fiber is supplied as reference. The peak from LiF and Fe is denoted by # and * respectively.

The annealed FeF₃-MLG carbon fiber electrode has XRD pattern similar to FeF₂-MLG carbon fiber electrode. Nanosize FeF₂ can undergo a psuedocapacitive type reaction in presence of electrolyte mixture that contains LiPF₆ to convert into FeF₃ as reported by Amatucci and other groups. Similar to the performance of slurry based FeF₃ electrode (FIG. 4a) the charge-discharge profile in FeF₃-MLG carbon fiber electrodes can also be categorized into two capacity/voltage regions. The cathodic peak between 3.0-2.5 V and the anodic peak between 3.3-3V are related to reaction 1 (insertion), and the corresponding plateaus at 1.8 V (cathodic) and the ˜2.8 V (anodic) are related to reaction 2 (conversion). The potential difference between the cathodic and anodic peaks for reactions 1 and 2 is about 0.4 V and 0.9 V, respectively. Significantly larger polarization of reaction 2 implies that the conversion reaction is intrinsically slower than the intercalation reaction. The rise of the FeF₃ redox potential after the first lithiation (discharge plateau #2 FIG. 4b) is attributed to an improvement of diffusion kinetics, which could be due to the reduction in particle size of the reconverted FeF₃. Similar behavior was also reported for other conversion compounds. For the slurry based composite electrodes, the capacity degrades rapidly and the cell loses its capacity completely in less than 15 cycles (FIG. 4c) whereas FeF₃ on fiber electrode architecture has steady capacity retention over more than 25 cycles (FIG. 4d). FIG. 5 is (a) voltage vs. capacity profiles of Li/FeF₃ cell (on carbon fiber) cycled between 1.0 V and 4.5 V (C/50 rate) at 25° C.; and (b) capacity plotted as a function of cycle number for the Li/FeF₃ cell. Lowering the voltage cut-off to 1 V instead of 1.5 V yields about 15% more capacity but there is also a significant increase in the voltage hysteresis (FIG. 5). However, such increase in capacity does not necessarily result in higher energy density because of the lower voltage window. Table 1 is a table of irreversible capacity loss, 1st lithiation capacity, reversible capacity, hysteresis and specific energy of FeF3 at various cut-off voltages and temperatures. Table 1 summarizes the specific capacity and electrochemical performance of FeF₃ electrodes under different voltage window and processing conditions.

| | | | | | | 2.3 V-4.5 V at |
|---|---|---|---|---|---|---|
| | 1.5 V-4.5 V at | 1.0 V-4.5 V at | | 1.5 V-4/5 V at | 2.3 V-4.5 V at | 60° C. |
| Parameters | 25° C. | 25° C. | | 60° C. | 25° C. | (1.5 V cut off) |
| Irreversible | 7.5 | 14.5 | | ~25 | | |
| capacity loss | | | | | | |
| (ICL) (%) | | | | | | |
| 1^{st} cycle lithiation | 465 | 528 | | 685 | 35 (1.5 V) | 175 |
| capacity (mAh/g) | | | | | | |
| Highest reversible | 445 (~2e⁻¹) | 595 | (2.5e⁻¹) | 692 (~3e⁻¹) | 150 (1.5 V) | 235 (1e⁻) |
| capacity (mAh/g) | | | | | 192 (1.0 V) | |
| Hysteresis (V) | 0.9-1.0 | 1.3 | (2^{nd} cycle) | 0.8 | 0.4 (1.5 V) | 0.35 |
| | | 1.7 | (30^{th} cycle) | | 1.5 (1.0 V) | |

| | | | | | |
|---|---|---|---|---|---|
| Specific Energy | 990-1010 | 1060 | 1650 | 460 (1.5 V) | 740 |
| (Wh kg⁻¹) | | | | 535 (1.0 V) | |

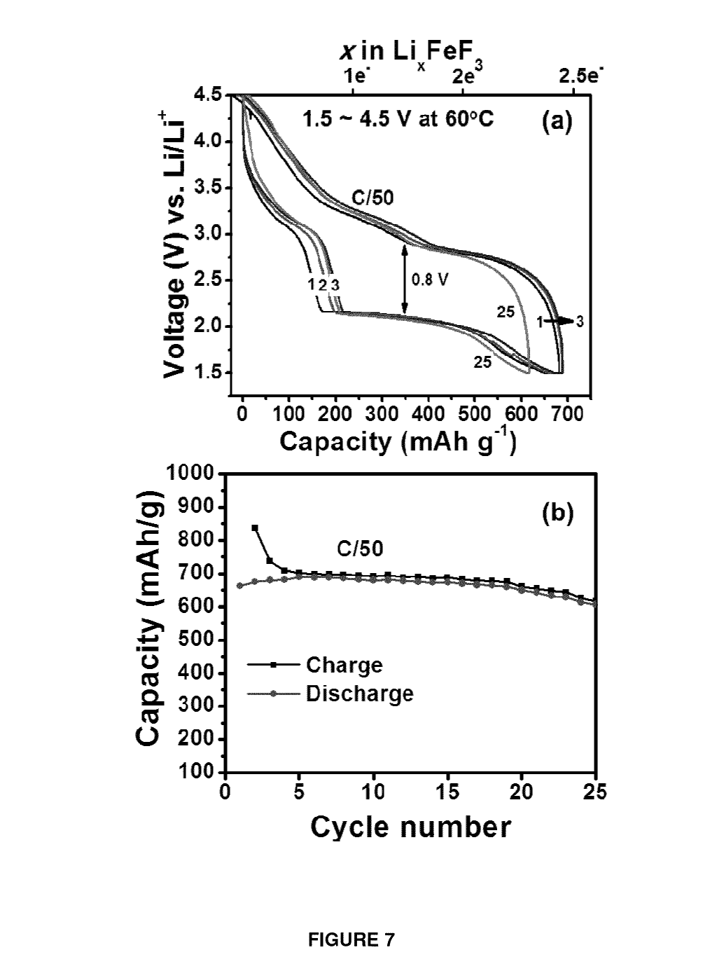

A dramatic improvement in electrochemical performance of similar FeF₃ carbon fiber electrodes is observed when cycled at 60° C. as shown in FIG. 7. FIGS. 7 (a)-(b) are (a) voltage vs. capacity profiles of a Li/FeF₃ cell (on carbon fiber) cycled between 1.5 V and 4.5 V (C/50 rate) at 60° C.; and (b) capacity plotted as a function of cycle number for the Li/FeF₃ cell. Capacity is evaluated based only on FeF₃ active material. Such improvement in the electrochemical performance can be explained due to combination of factors such as activated diffusion inside the FeF₃ particle and/or increased interfacial charge transfer kinetics. Unlike the 25° C. results a higher discharge plateau for 60° C. (˜2.1 V) during the 1^{st} cycle itself is found. There is also a marginal improvement in voltage hysteresis from 0.9 V at 25° C. to 0.8 V at 60° C. More importantly, the enhanced ion diffusion kinetics (at 60° C.) enables reversible three electron capacity of around 700 mAhg⁻¹ (close to theoretical capacity) as shown in FIG. 7a. A stable cycling behaviour is found with capacity retention >600 mAh V for more than 25 cycles (FIG. 7b). This evidences the role of electrode architecture in further improving the electrochemical performance. An aspect of 60° C. cycling is the undesirable side reactions between the electrolyte and electrode materials that could get accelerated at elevated temperatures and manifest as poor columbic efficiency during the first few cycles. These reactions could result from oxidation of electrolyte by itself or reaction with surface electrode species and/or carbon. The capacity values reported in FIGS. 4 and 7 are with respect to weight of the active material, FeF₃. When normalized to the total mass of the electrode material (active material+MLG+pitch binder) the discharge capacity of FeF₃-MLG at 1.5V cut off voltage is about 334 mAh/g at 25° C. and 519 mAh/g at 60° C. It is significant to note that within the intercalation window, the FeF₃-MLG carbon fiber electrode can deliver more than 235 mAh g⁻¹ at 60° C. (close to the theoretical capacity) with an average discharge voltage of about 3.25 V. The voltage hysteresis is only about 0.35 V in this range (2.3-4.5 V). From the experimental cycling data the estimated specific energy (the product of capacity and the operating voltage) is about 740 Wh kg⁻¹, and 490 Wh kg⁻¹ at 25° C. This by itself is comparable to most of the conventional Li-ion battery intercalation cathodes. The estimated overall energy density based on the active mass of FeF₃ in the electrode is about 1650 Wh kg⁻¹ covering both the intercalation and conversion window (1.5-4.5 V). Although the XRD (FIG. 6) of FeF₃-MLG electrode shows FeF₂ like phase to start with, it takes only a few cycles for electrodes to behave like FeF₃ as shown by the clear intercalation peak around 3V in FIG. 4b followed by conversion reaction. Further, when these electrodes are stored under ambient condition they mostly convert back to FeF₃ as shown by the 1^{st} discharge cycle plot in FIG. 7.

FIGS. 8 (a)-(b) are (a) rate performance of the FeF₃-MLG carbon fiber electrode, cycled beteen 1.0 V and 4.5 V; and (b) the corresponding voltage profiles at different rates. FIG. 8 shows the C-rate performance at room temperature (25 C) for FeF₃-MLG electrodes beginning from very low rates (C/86) to 10 C. The electrodes show very complicated rate kinetics because of the combined intercalation and conversion charge transfer processes. For current rates >C/20 the voltage profile is suppressed to below 1.5V and significant fraction of conversion capacity is in the region between 1.5-1V which may not be very useful if considered as a cathode. Within the intercalation range (4-2.5V) there is not much capacity loss between C/86-5C and full capacity is obtained close to 200 mAh/g. There is even significant capacity retention at 10C in the intercalation region. Except for the C/20 discharge profile (FIG. 8b) the conversion plateau moves to lower voltages with increasing current rate. Such polarization could be a signature of poor kinetics associated with conversion phases as has been noted earlier. The discharge profiles (FIG. 8) clearly show that considerable capacity is lost at high discharge rates.

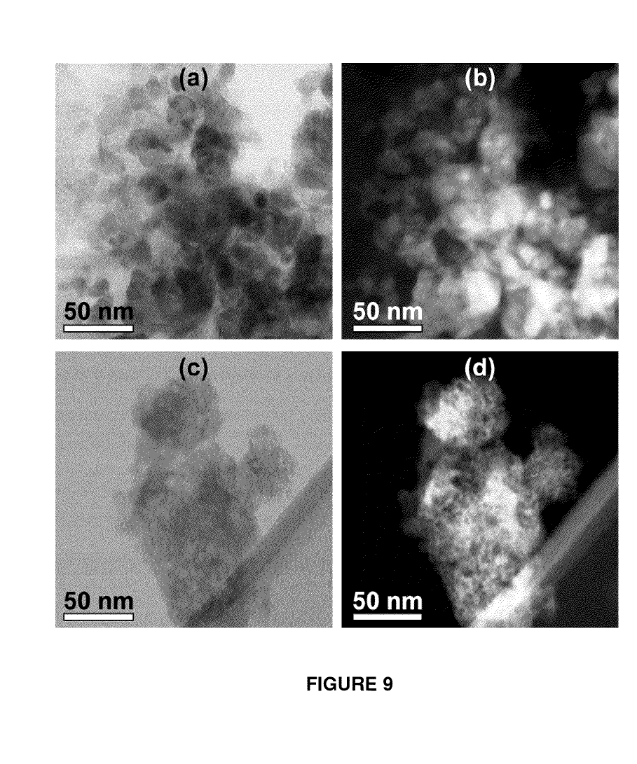

The local microstructure of the starting iron fluoride phase and their constant evolution during the repeated conversion process during cycling has significant effect on their electrochemical performance. High resolution electron microscope studies on pristine and cycled FeF₃ electrodes were conducted. The local structure of pristine and discharged (lithiated) FeF₃-MLG particles was examined by bright-field and Z-contrast imaging with aberration-corrected scanning transmission electron microscopy (STEM) as shown in FIG. 9. FIGS. 9 (a)-(d) are STEM images (a) bright field, (b) Z-contrast of FeF₃ from pristine electrode and (c) bright field, (d) Z-contrast of FeF₃ from cycled electrode after cycling between 1.5 V and 4.5 V after 50 cycles at 60° C. The images show that cycled FeF₃ particles in fully discharged (lithiated) state have much finer particle size approximately in the range of 1-2 nm (FIGS. 9 c,d) compared to pristine (or uncycled) FeF₃-MLG (FIGS. 9 a,b). This can be attributed to the formation of nucleated phases of Fe nanoparticles surrounded by LiF during the discharge process. Elemental analysis of the discharged FeF₃ particles using STEM was difficult as the sample was very susceptible to the electron beam damage (even at a lower flux and using different acceleration voltages, i.e. 60 kV and 100 kV). However XRD results on the discharged FeF₃-MLG electrode (FIG. 6) show of broad peaks corresponding to nanometer sized LiF and Fe indicating formation of conversion reaction products under fully discharged condition. Similar results were observed for the discharged FeF₂ electrode as well. The results provide evidence that a major part of the hysteresis could stem from the kinetic overpotential during the reconversion which has its origin from difference in ionic mobility between Li and Fe: with Li being more mobile than Fe²⁺. This could lead to the formation of Fe⁰ precipitates locally with much slower intermixing with LiF phase, to form the parent LiFeF₃. Consequently, the voltage plateau during the charge (reconversion) is then determined by ability of the Fe clusters to react with LiF, which depends on the exact nature of their interfacial interphase and various kinetically stabilized reaction pathways.

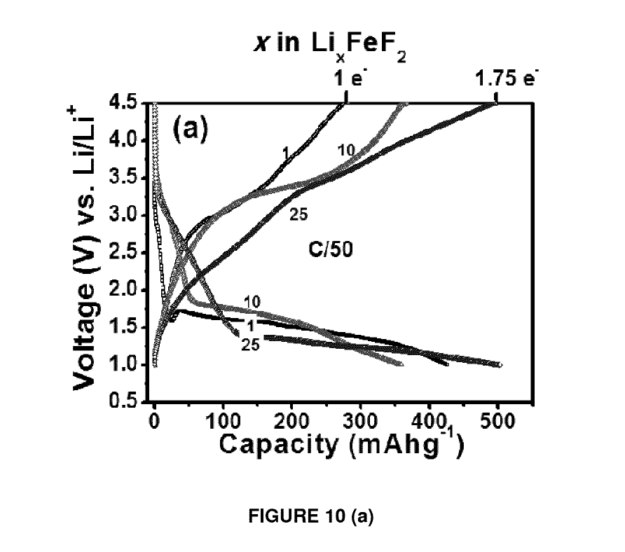

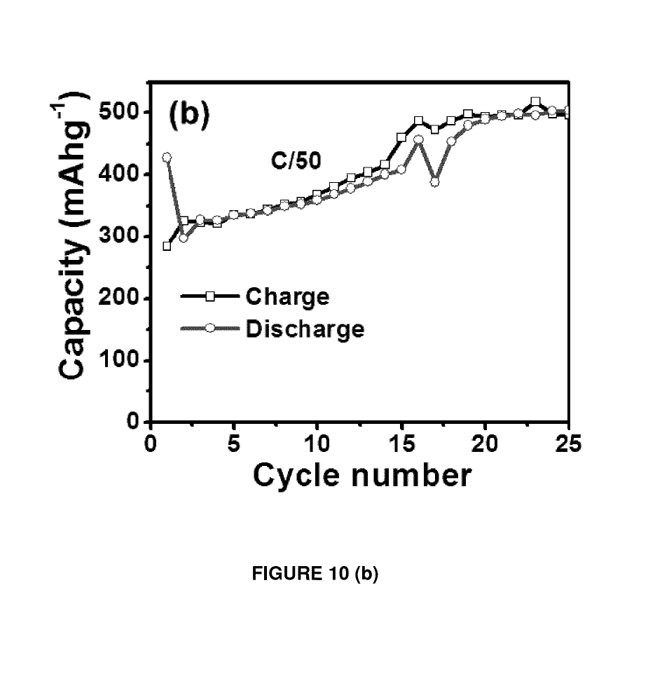

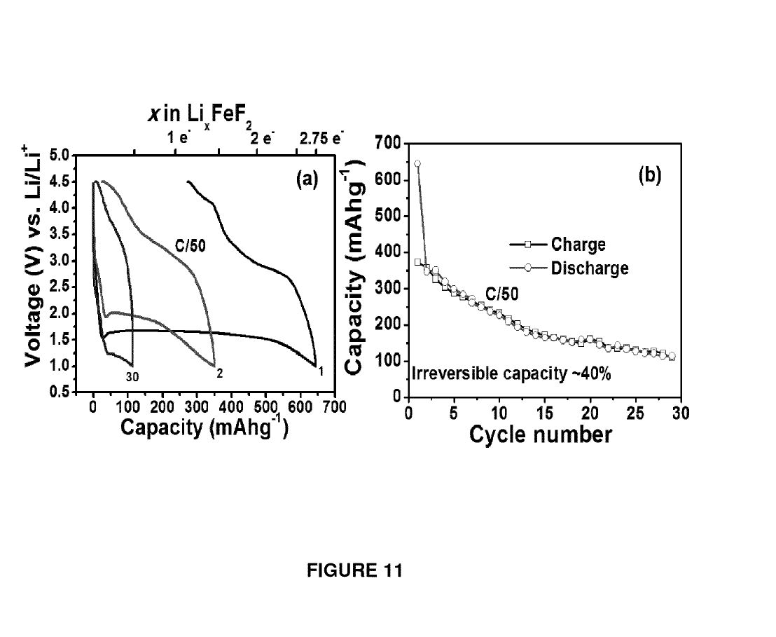

The FeF₂-MLG carbon fiber 3D electrode was also fabricated by the same synthesis & processing method but their electrochemical performance was not as robust as FeF₃. FIGS. 10 (a)-(b) are (a) voltage vs. capacity profiles of a Li/FeF₂ cell (on carbon fiber) cycled between 1.0 V and 4.5 V (C/50 rate) at 25° C.; (b) capacity plotted as a function of cycle number for the Li/FeF₂ cell. Capacity is evaluated based on FeF₂ active material. FIG. 10a shows the charge-discharge voltage profile of the FeF₂-MLG nano-composite electrode cycled at C/50 rate at room temperature between 4.5-1 V window. The reversible capacity of FeF₂-MLG nano-composite electrode gradually increases with cycling with a capacity feature appearing between 3-2.5 V similarly similar to FeF₃. The result suggests slow oxidation of a FeF₂ to a FeF₃ under electrochemical condition as discussed earlier. Notably, the discharge capacity increases from ˜400 mAhg⁻¹ in the 1st cycle to 500 mAhg⁻¹ at the end of 20^{th} cycle corresponding to 1.75 electron capacity. On the contrary, FeF₂ (similar particle size) electrode fabricated by conventional slurry method shows full capacity (2 electrons) in the 1st cycle and the capacity thereafter decreases to 100 mAhg⁻¹ at the end of the 30^{th} cycle (FIG. 11). There could be some kind major structural and phase rearrangement between the 1st and 2nd electrochemical cycle (for the slurry electrodes) leading to rapid decrease in capacity and thereafter the capacity declines steadily. Unlike FeF₃, FeF₂-MLG carbon fiber electrodes show large hysteresis (˜2 V) although they use similar carbon fiber based electronic scaffold and are processed under identical synthetic parameters with same weight percent of MLG and pitch. The only difference is the average particle size for FeF₂, is a factor two larger than FeF₃ (FIG. 2). The origin of higher hysteresis for FeF₂ is at present not clear and could be beyond just the particle size effect. Nevertheless, the carbon fiber architecture provides much improved electrochemical performance compared to slurry based as explained above.

The electrochemical performance of such iron fluoride-carbon fiber electrodes was compared with respect to the conventional slurry based iron fluoride electrode under similar materials and electrode design parameters such as particle size loading. The convention slurry electrodes coated on aluminium foil have very poor capacity retention even with a higher conductive carbon (MLG) loading. At room temperature we obtain reversible discharge capacity close to 595 mAh g⁻¹ (between 4.5-1.0 V) and 445 mAh g⁻¹ (operating voltage 4.5-1.5 V) for FeF₃ carbon fiber electrodes. The corresponding value of for FeF₂-MLG fiber electrode is 500 mAh g⁻¹ (operating voltage 4.5-1.0 V). Full three-electron capacity could be obtained for FeF₃ composite cathodes when they are cycled at 60° C. corresponding to 85% of its theoretical energy density (1951 Wh kg⁻¹). The voltage hysteresis is significantly reduced from ˜2 V for PVDF-CB based slurry electrodes to about 0.9 V for the fibre 3D architecture improving the roundtrip efficiency by more than 50%. The increase in capacity retention, reduction in voltage hysteresis and improved cyclability observed for the iron fluoride system indicate the importance of electrode architecture and other relevant material parameters such as particle size and electronic conductivity. Although the majority of electrochemical are based on C/50 C-rate, FeF₃-MLG electrodes show very good rate performance in the intercalation region (up to 10C). There is still reasonable capacity retention at higher rates in the conversion region but the voltage profiles are pushed lower than 1.5 V due to poor transport kinetics. Furthermore, this electrode approach potentially eliminates the use of organic binders and conductive diluent that could reduce the inactive materials weight by as much 15 wt. %. Absence of the regular Al current collector has a relative weight reduction by 40% (per normalized mass with respect to carbon fiber mat). This could improve the active materials loading resulting in increasing the energy density by ˜20-25% at the cell level. The reversibility of the conversion reaction phases can depend on a variety of factors such as, the kinetics of the discharge phases, their internal microstructure and also the electrochemical variables that governs the charge-discharge process such as current rate, and the voltage window.

This invention can be embodied in other forms without departing from the spirit or essential attributes thereof. Reference should accordingly be made to the following claims to determine the scope of the invention.

We claim:

1. An electrode for a battery, comprising:
a plurality of electrochemically active conversion-based particles coated by multilayer graphene;
a plurality of carbon fibers; and,
a carbonaceous binder binding the multilayer graphene coated particles to the plurality of carbon fibers.

2. The electrode of claim 1, wherein the electrochemically active conversion-based is iron-containing.

3. The electrode of claim 2, wherein the iron-containing active particles comprise iron fluorides, iron oxyfluorides, iron oxynitrofluorides and iron nitrides.

4. The electrode of claim 2, wherein the iron-containing active particles comprise at least one selected from the group consisting of FeF₂, FeF₃, and FeOₓF₁₋ₓ, where x=0 to 0.5.

5. The electrode of claim 1, wherein the carbon fibers have a diameter of between 100 nm and 5 microns.

6. The electrode of claim 1, wherein the carbon fibers are in the form of a woven mat.

7. The electrode of claim 4, wherein the mat can have a thickness of between 100 microns and 1 millimeter.

8. The electrode of claim 1, wherein the carbonaceous binder comprises pitch.

9. The electrode of claim 1, wherein the loading of electrochemically active conversion-based particles is between 2-15 mg/cm².

10. The electrode of claim 1, wherein the electrode thickness is between 100-250 microns and the loading of electrochemically active conversion active particles is between 2-6 mg/cm².

11. The electrode of claim 1, wherein the electrode thickness is between 300 microns and 1 mm and the loading of electrochemically active conversion active materials is between 6-15 mg/cm².

12. The electrode of claim 1, wherein the pitch precursor and electrochemically active conversion-based particles comprise between 5-15 wt % based on the total weight of the electrode.

13. The electrode of claim 1 wherein the pitch precursor and electrochemically active conversion-based particles each comprise between 5-15 wt % of the total electrode weight.

14. The electrode of claim 1, wherein the multilayer graphene comprises between 10-25 wt % of the total electrode weight.

15. The electrode of claim 1, wherein the electrochemically active conversion-based particles are between 5-50 nm.

16. The electrode of claim 1, wherein the electrochemically active conversion-based particles are provided in secondary aggregates of between 1 and 5 microns.

17. The electrode of claim 1 wherein the multilayer graphene comprises platelets having a thickness of between 5 nm and 25 nm.

18. The electrode of claim 1, wherein the multilayer graphene comprises platelets having a diameter of between 5 and 20 microns.

19. The electrode of claim 1, wherein the electrode is provided in a battery.

20. The electrode of claim 1, wherein the electrochemically active conversion-based particle comprises at least one selected from the group consisting of transition metal fluorides, oxides, nitrides, oxynitrides, and phosphides.

21. The electrode of claim 1, wherein the electrochemically active conversion-based particle comprises at least one selected from the group consisting of Fe₂O₃, Fe₃O₄, CoO, Co₃O₄, CuO, Cu₂O, Co₃N, VN, FeP_{y}, where y=0.33, 0.5, 1, 2, and 4, NiP_{y}, where y=0.33, 0.5, 2, and 3, CuP₂, and CrF₃/C.

22. A battery comprising an electrode, the electrode comprising:
a plurality of electrochemically active conversion-based particles coated by multilayer graphene;
a plurality of carbon fibers; and,
a hydrocarbon binder binding the multilayer graphene coated particles to the plurality of carbon fibers.

23. A method of making a battery, comprising the steps of:
providing a plurality of electrochemically active conversion-based particles;
coating the active particles with a multilayer graphene;
mixing the active particles coated with the multilayer graphite with carbon fibers and a carbonaceous binder;
carbonizing the carbonaceous binder to bind the active particles coated with multilayer graphene to the carbon fibers.

24. The method of claim 23, wherein the electrochemically active conversion-based particle comprises at least one selected from the group consisting of transition metal fluorides, oxides, nitrides, oxynitrides, and phosphides

25. The method of claim 23, wherein the carbonization step is conducted at temperatures of between 400-600° C.
